(19) United States
(12) Patent Application Publication
(10) Pub. No.: US 2004/0122933 A1
(43) Pub. Date: Jun. 24, 2004

(54) Interface for non-typed direct access to sponsored sites on the internet

(76) Inventors: Paulo S.S. Franqueira, Sao Paulo (BR); Victor G. Simonsen Filho, Sao Paulo (BR)

Correspondence Address: SHAPIRO COHEN, P.O. BOX 3440, STATION D, OTTAWA, ON, K1P6P1, CA

(21) Appl. No.: 10/470,970

(22) PCT Filed: Feb. 6, 2002
(86) PCT No.: PCT/BR02/00026

(30) Foreign Application Priority Data
Feb. 7, 2001 (BR) PI 0106473-8

(51) Int. Cl. G06F 15/173

(52) U.S. Cl. 709/223

(57) ABSTRACT

The invention refers to an interface that allows direct non-typed access to Internet partner sites. It also refers to an equipment provided with said interface, to a method to effect direct non-typed access to partner sites and also to a method to make viable the use of microcomputers by means of the presence of said interface.

The invention refers to an interface that allows direct non-typed access to Internet partner sites. It also refers to an equipment provided with such interface, to a method to effect direct non-typed access to partner sites and also to a method of enabling the use of microcomputers through the presence of said interface.

The use of microcomputers for Internet access is widely spread, mainly through modem connections, phone lines and browser softwares, such as Internet Explorer and Netscape.

According to the standards of such browsers, once the connection with the provider is effected, a pre-established page opens up, whose address is recorded as default within the software and can be either an Internet address is or a file of the computer itself. To visit other desired sites, the user is forced to type the desired URL within the address field and type “enter”.

Even if apparently simple, this method for access to a desired Internet site is bothersome to people who are less familiar with microcomputers. Even users who are more familiar with computers are subject to typing errors, especially for more complex addresses, and this inconvenience requires re-typing. A palliative solution is the use of resources such as the folders “history” or “favorites”, in which the user has the option to select those sites whose addresses have been deliberately saved, but only after a first access has already been achieved.

A few attempts to make Internet access easier, claiming the elimination of the complexity from operating a microcomputer, are sets basically comprising a keyboard linked to a modem, requiring a connection to a television monitor. In Brazil, devices of this kind are known and sold under the trade names “My Web” and “Easy Box”.

Such sets present various disadvantages. Just like any common system for Internet access, for instance, the access to any desired site requires typing the address followed by the “enter” key, thus not presenting any easy use for those users who are less familiar with Internet. Since such sets present limited software and hardware resources, besides sending images only through a TV set, image reproduction has low resolution, thus causing dissatisfaction among users. Such sets do not allow any other feature different from Internet access and Internet navigation, without offering the possibility of downloads or uploads of any kind, as memory, disk drivers or any other appropriate components necessary to this end are not available. Without an operational system such as Windows or any other, accessible to the user, the use of the computing power included therein is not available for any additional use, such as a text editor, spreadsheet, etc. And finally, since the cost/benefit ratio for those sets is very poor (thus justifying their rather limited sale success), their adoption by users with less purchasing means is not viable.

There are no options in the state of the art simultaneously allowing:

fully simplified access to Internet sites;

use of computational power at least for basic software, such as text editor, spreadsheet software, email;

low price or free availability, thus facilitating the access to any and all Internet sites in the conventional way, and the use of microcomputer by people with lower financial income.

The invention presents solutions to solve or largely remedy the problems indicated in the state of the art.

In a first aspect of the invention, it concerns an interface for non-typed access to partner sites, which comprises an input device (preferably a key) provided with means (preferably visual and illuminated) for the identification of each said partner, whose single-touch activation promotes direct access to the site of said partner as therein identified.

Said input device can be a mechanically activated key or a touch-sensible key, a pressure sensor, switch, joystick or any other device whose single-action activation provides direct access to the partner site. For easier explanation, the text that follows refers to the input device simply as a “partner key”, bringing no limitation to its meaning.

The advantages issued from the use of partner keys are promptly perceived:

typing of the corresponding address is avoided, thus eliminating any difficulty to access the partner site, especially for those people who are less familiar with the use of microcomputers;

typing errors are avoided, since the partner site address is pre-configured with relation to the corresponding key, identified by its name and/or logo;

advantageously to the partner, the partner key is already configured in an unchangeable way when given to the user's hands, with no possibility to re-configure it by assigning it to another address or changing its access function in any way.

computational features associated to the set are made available, that is, up to the point allowed by the operational system, any software can be run, typically a text editor, electronic spreadsheet and email, also allowing the use of accessories such as a printer, card reader, bar code reader, web cam, etc.

Typically, the invention comprises, associated to the ordinary keyboard of a microcomputer, a block of partner keys which are easily identified, each one with the identification of a partner (e.g. name and/or logo), so that the direct access to the site of each one is accomplished by only touching the specific key, with no other associated command.

The identifying means for a partner key may be visual, by sound or any other appropriate means, preferably the name and/or logo of the partner affixed over or near the partner key. Also preferably said partner key is illuminated, highlighting the partner identification (given that an “illuminated” key is a key linked to a source of light, which is preferably internal to the key, highlighting it from the environment). But any other means of appropriate identification can be used, such as numbers, letters, symbols, printed in low or high relief, emission of sounds and/or lights, etc.

Advantageously, more than one single partner key is used, appropriately between 2 and 50, preferably between 3 and 20, more preferably between 5 and 10 partner keys. Within the text below, “key support” means one or more partner keys present on some kind of common basis or support. There are no limitations as to the size or form for partner keys.

Preferably, the partner key support is an integral part of the microcomputer keyboard. The scope of the invention also includes one or more key supports which may be linked together in a definitive or non definitive manner, for instance modularly, also linked to any computer accessory, individually or additionally, e.g. linked to the mouse and/or monitor and/or CPU and/or also separate from the computer or any other accessory.

The link between the key support and the microcomputer can be any one known by a person skilled in the art, as long as it performs the proposed feature, that is to allow the access to the sponsored site with a single touch. Non-limitative connection examples are made by means of metal cable, optical fiber or infrared emission.

Partner keys are pre-programmed by any known means, so that their activation allows direct access to the address of the corresponding partner site. In a didactic manner, each key is associated to the pre-programmed partner address which is stored in an appropriate place within the memory of the equipment, the operational system software or wherever appropriate, so that a single touch from the user provides the sending of the pre-programmed address to the Internet provider by telecommunication connection (dialed access, large bandwidth, DSL, ADSN, etc.) as if it had been typed, bringing the partner site to the screen or equivalent output device.

A typical output device is a screen for visualization, which can be as known, be it a color or black and white monitor, a liquid crystal display, a television set or any other. There can be more than one simultaneous output device for the interface of the invention.

Within another aspect of the invention, an equipment provided with an interface for non-typed access to partner sites is also disclosed. Such an equipment comprises appropriately keyboard, mouse, modem, processor chip, memory, disk driver, CPU and an appropriate operational system, such as Microsoft Windows CE 3.0, in which text editing software, such as Microsoft Word, and electronic spreadsheet software, such as Microsoft Excel, can run.

Appropriately, the equipment of the invention, which is equipped with the interface for non-typed access to partner sites, comprises a small display linked to the keyboard, where additional information of any kind is shown, preferably the connection speed of the current session. The equipment of the invention must be connected to an image output device to show the partner site, typically a monitor which is physically distinct from other components of the equipment (e.g. a television monitor or computer monitor).

The equipment of the invention-can be optionally equipped with a printer output, a video output (PAL-M, NTSC, NTSC-M or any other), an audio output, etc. An advantageous accessory of the equipment of the invention is a reader of magnetic cards, known as “smart cards”, that can be used as a support for transactions related to the partner sites. If a partner is a bank, for instance, the identification of the account owner can be achieved by passing the magnetic card with previously saved data from such account owner through the card reader, thus avoiding tedious and error-prone typing and providing a quick and efficient operation, even to those people who are less familiar with the complexity of a microcomputer.

Another aspect of the invention is the method for non-typed access to partner sites, which comprises the following steps:

establishing communication with an Internet service provider;

directly accessing a partner site by activating an input means of an interface for non-typed access to partner sites, said input means being provided with means for the identification of said partner and said activation consisting essentially of a single touch;

optionally navigating through the partner site and optionally interacting according to the possibilities as offered therein.

A further aspect of the invention is a method to enable the use of microcomputers through the presence of an interface for non-typed access to partner sites, comprising the following steps:

supplying an equipment with an interface for direct non-typed access to partner sites, as described above;

assigning each partner to a key for direct access to the corresponding site, with each partner negotiating resources with the equipment supplier for the use of the partner key;

supply of said equipment at low cost or free of charge to people of interest.

As used herein, “to negotiate resources” means the offer and/or effective transference of resources, both material (e.g. cash) and non-material (e.g. disclosing a meritorious cause), both on the part of the equipment provider and on the part of the partner, in the benefit of any of those parties or others.

“People of interest” means any persons who may potentially interact with the equipment. From the perspective of one such person of interest, the appeal is to obtain or use the equipment in a very cheap or even free manner, enabling access to the Internet and/or the use of the equipment itself. From the perspective of the equipment supplier, the granting for free allowing the use or selling the equipment for a very low price may be leveraged by interested corporations or institutions. From the perspective of a partner, the advertising of its name and the enabling of very easy access to its site is provided. Non-limiting examples of people of interest are as follows:

people who are less familiar with computers and who only want to eventually access a specific site (e.g. their banks, their children's schools, their companies, a government site, etc.), with no need to learn how to operate a computer;

informatics students;

people not holding enough financial power to purchase a traditional microcomputer, who then have the opportunity to become integrated to the virtual world and email;

customers of any partner institution;

members of labor or trade unions willing to be updated about their institution itself;

schools and learning institutions to give remote classes to their students.

A beneficial effect of the various aspects of the invention is to provide an efficient vehicle for education in general, reducing or even removing the barriers (lack of computer, lack of Internet access) that limit people's access to information sources.

Below there is a typical example of the invention, given as a mere illustration of said invention, not imposing any limitation which is different from those presented in the attached claims.

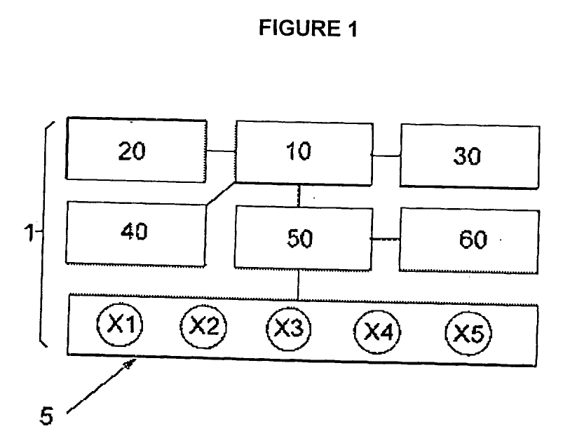

FIG. 1 shows a preferential aspect of the invention, which is an equipment provided with an interface for non-typed access to Internet partner sites.

This is an equipment generically designated as 1, comprising a partner key support 5, a CPU 10, a television or computer monitor 20, a “smart card” reader 30, a modem 40, a keyboard 50 and a liquid crystal display 60.

The set as supplied to the user does not include the television or monitor 20, which can be, for instance, those available to the user at home and used to provide the equipment 1 with an image output. Keyboard 50 is a standard keyboard for microcomputers, associated to a display 60 showing the Internet connection speed.

The partner key support 5, associated to the keyboard 50, is provided with five partner keys, on which X1 is the identification symbol for partner X!, X2 is the identification symbol for partner X2 and subsequently until X5.

The equipment is provided with an Internet browser software which is able to display Internet pages accessed by a telecommunication channel by means of the modem 40.

Once the access to the Internet is obtained, the user gets direct access to partner X1 simply by pressing the key which is plainly identified as the X1 partner. And subsequently for each one of the other partners from X2 to X5.

The equipment 1 can be used for email exchange over the Internet and also runs software over the chosen operational system. If the operational system is Microsoft Windows CE 3.0, other softwares can be used over that platform, such as a text editor, electronic spreadsheet and others.

1. Interface for direct non-typed access to partner sites, which comprises an input device provided with means for the identification of each one of said partners, whose activation with one single touch promotes direct access to the site of said partner as therein identified.

2. Interface of claim 1, wherein said input device is a key or a set of two or more keys, which are preferably illuminated.

3. Interface of claim 2, wherein said input device is a set of keys over a support containing between 2 and 50 keys, preferably between 3 and 20 keys, more preferably between 5 and 10 keys.

4. Interface of claim 1, wherein said identification means is an identification symbol of each one of said partners, preferably its name and/or logo.

5. Equipment provided with an interface for direct non-typed access to partner sites, wherein said interface is the one disclosed in any of claims 1 to 4.

6. Equipment of claim 5, comprising keyboard, mouse, modem, processor chip, memory, disk driver, CPU and an operational system.

7. Equipment of claim 5, wherein said keyboard is associated to a display showing information of any kind, preferably the Internet connection speed.

8. Equipment of claim 6, additionally comprising a “smart card” reader.

9. Equipment of claim 6, wherein said operational system is Microsoft WINDOWS CE 3.0.

10. Equipment of claim 6, wherein the input device of said interface is a support with one key or with a set of two or more keys, said equipment comprising one or more key supports which are associated to each other in a definitive or non-definitive manner, associated to any accessory of the computer, individually or additionally, for instance associated to the keyboard and/or mouse and/or monitor and/or CPU and/or being distinct from the computer or from any other accessory.

11. Equipment of claim 10, comprising only one key support associated to the keyboard in a definitive manner.

12. Method for direct non-typed access to partner sites which comprises the following steps:
establishing communication through a telecommunication connection with an Internet service provider;
directly accessing a partner site by activating an input device of an interface for direct non-typed access to partner sites, said input device being provided with means for the identification of said partner and said activation consisting essentially of a single touch;
optionally navigating through the partner site; and
optionally interacting according to the possibilities as offered therein.

13. Method of claim 12, wherein said interface is as disclosed in any of claims 1 to 4.

14. Method to enable the use of microcomputers through the presence of an interface for direct non-typed access to partner sites, comprising the following steps:
providing an equipment with an interface for direct non-typed access to partner sites, said equipment being as disclosed in any of claims 5 to 11;
assigning each partner to a key for direct access to the corresponding site, with each partner negotiating resources with the equipment supplier for the use of the partner key;
supplying said equipment at low cost or free of charge to people of interest.
